(19) United States
(12) Patent Application Publication
(10) Pub. No.: US 2024/0208588 A1
(43) Pub. Date: Jun. 27, 2024

(54) VEHICLE BODY CONNECTING STRUCTURE

(71) Applicants: Hyundai Motor Company, Seoul (KR); Kia Corporation, Seoul (KR)

(72) Inventors: Seokju Gim, Seongnam-si (KR); Chulhee Heo, Hwaseong-si (KR); Hoyeon Kim, Suwon-si (KR)

(21) Appl. No.: 18/461,195

(22) Filed: Sep. 5, 2023

(30) Foreign Application Priority Data
Dec. 21, 2022 (KR) 10-2022-0181017

(51) Int. Cl. B62D 27/02; B62D 25/02; B62D 25/04; B62D 25/06

(52) U.S. Cl. CPC B62D 27/02; B62D 25/02; B62D 25/04; B62D 25/06

(57) ABSTRACT

An embodiment connecting structure for a vehicle body includes a vehicle body side part including a roof and a side outer connected with the roof, a quarter pillar upper reinforcement including a pillar upper reinforcement body and an upper connecting flange protruding from the pillar upper reinforcement body, the pillar upper reinforcement body having an upper tubular closed cross-section, and an upper flange bracket connected with the pillar upper reinforcement body and defining a quarter upper skeleton in a length direction of an upper portion, wherein the quarter pillar upper reinforcement is mounted inside the vehicle body side part through the upper connecting flange and the upper flange bracket.

### CROSS-REFERENCE TO RELATED APPLICATIONS

This application claims the benefit of Korean Patent Application No. 10-2022-0181017, filed on Dec. 21, 2022, which application is hereby incorporated herein by reference.

### TECHNICAL FIELD

The present invention relates to a vehicle body connecting structure.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV is an electric vehicle (EV)-based environment-friendly vehicle that provides various customized services to users. These PBVs can be developed in various forms such as occupant transport and cargo transport.

However, in order to design and produce various vehicle specifications according to the needs of various users, many mold changes are required for the production of vehicle body parts.

In the case of a general panel type structure, object press parts such as a quarter inner, a quarter upper, and a center reinforcement are required for changing vehicle specifications, and new development of various parts is required when changing specifications and body type, such as the PBV.

The above information disclosed in this background section is only for enhancement of understanding of the background of embodiments of the invention, and therefore it may contain information that does not form the prior art that is already known to a person of ordinary skill in the art.

### SUMMARY

The present invention relates to a vehicle body connecting structure. Particular embodiments relate to a vehicle body connecting structure that may be flexibly applied to various vehicle types.

Embodiments of t present disclosure provide a vehicle body connecting structure that can be flexibly applied to various vehicle types according to the needs of various users.

A vehicle body connecting structure according to an exemplary embodiment may include a vehicle body side part including a roof and a side outer connected with the roof, a quarter pillar upper reinforcement including a pillar upper reinforcement body of which an upper tubular closed cross-section is formed thereto and an upper connecting flange formed to protrude from the pillar upper reinforcement body, and an upper flange bracket that is connected with the pillar upper reinforcement body and forms a quarter upper skeleton in the length direction of the upper portion. The quarter pillar upper reinforcement is mounted inside the vehicle body side part through the upper connecting flange and the upper flange bracket.

The upper connecting flange may be connected to the roof, and the upper flange bracket may be connected to the side outer.

The upper flange bracket may be connected with an exterior surface of the pillar upper reinforcement body.

A component mount hole may be formed in the pillar upper reinforcement body.

The vehicle body connecting structure according to an exemplary embodiment may further include at least two pillar parts disposed in the height direction of the vehicle body to form a lateral skeleton of the vehicle body and a quarter pillar lower reinforcement mounted on the lower portion of the quarter pillar upper reinforcement to connect the pillar parts.

The quarter pillar lower reinforcement may include a pillar lower reinforcement body of which a lower tubular closed cross-section is formed thereto and a lower connecting flange protruded from the pillar lower reinforcement body and connected with the side outer.

The quarter pillar lower reinforcement may include a pillar lower reinforcement body of which a lower tubular closed cross-section is formed thereto and a lower flange bracket connecting the pillar lower reinforcement body and the side outer.

The vehicle body connecting structure according to an exemplary embodiment may further include a joint bracket connecting the pillar part and the quarter pillar lower reinforcement.

The vehicle body connecting structure according to an exemplary embodiment may further include a side outer support bracket connecting the quarter pillar upper reinforcement and the quarter pillar lower reinforcement.

The side outer support bracket may include a side outer support bracket flange formed to surround the quarter pillar upper reinforcement and the quarter pillar lower reinforcement at both ends thereof, respectively.

The connecting flange may be connected to the side outer, and the upper flange bracket may be connected with the roof.

According to the vehicle body connecting structure according to an exemplary embodiment, it can be flexibly applied to various vehicle types according to various user needs.

According to the vehicle body connecting structure according to an exemplary embodiment, production cost can be lowered and productivity can be increased by using common parts.

In addition, effects that can be obtained or predicted due to the embodiments of the present invention will be directly or implicitly disclosed in the detailed description of the embodiments of the present invention. That is, various effects expected according to embodiments of the present invention will be disclosed within the detailed description to be described later.

### BRIEF DESCRIPTION OF THE DRAWINGS

Since these drawings are for reference in explaining exemplary embodiments of the present invention, the technical idea of embodiments of the present invention should not be construed as limited to the accompanying drawings.

FIG. 1 is a perspective view of a vehicle body to which a vehicle body connecting structure according to an exemplary embodiment may be applied.

FIG. 2 is a perspective view excluding a side outer of the vehicle body to which the vehicle body connecting structure according to an exemplary embodiment may be applied.

FIG. 3 is a partial side view of the vehicle body to which a vehicle body connecting structure according to an exemplary embodiment may be applied.

FIG. 4 is a cross-sectional view along line IV-IV in FIG. 1.

FIG. 5 is a perspective view of a quarter pillar upper reinforcement part of the vehicle body connecting structure according to an exemplary embodiment.

FIG. 6A and FIG. 6B are side views of the quarter pillar upper reinforcement part of the vehicle body connecting structure according to an exemplary embodiment.

FIG. 7 is a perspective view of an upper flange bracket of the vehicle body connecting structure according to an exemplary embodiment.

FIG. 8 is a cross-sectional view along line VIII-VIII in FIG. 3, and it shows a quarter pillar lower reinforcement part of the vehicle body connecting structure according to an exemplary embodiment.

FIG. 9A and FIG. 9B are cross-sectional views showing exemplary variations of a quarter pillar lower reinforcement part of the vehicle body connecting structure according to an exemplary embodiment.

FIG. 10 is a partial perspective view viewed from the inside of the vehicle body to which the vehicle body connecting structure according to an exemplary embodiment may be applied.

FIG. 11 is a partial perspective view from the outside of the vehicle body to which the vehicle body connecting structure according to an exemplary embodiment may be applied.

FIG. 12 is a partially exploded perspective view viewed from the inside of the vehicle body to which the vehicle body connecting structure according to an exemplary embodiment may be applied.

FIG. 13A and FIG. 13B are drawings showing application examples of the vehicle body connecting structure according to an exemplary embodiment.

FIG. 14A, FIG. 14B, and FIG. 14C are drawings showing examples of a vehicle body connecting structure applied to vehicle bodies of various specifications.

FIG. 15 is a partial cross-sectional view of a vehicle body connecting structure according to the modified exemplary embodiment of the present invention.

### DETAILED DESCRIPTION OF ILLUSTRATIVE EMBODIMENTS

Hereinafter, with reference to the accompanying drawings, embodiments of the present invention will be described in detail so that those skilled in the art can easily carry out embodiments of the present invention.

As those skilled in the art would realize, the described embodiments may be modified in various different ways, all without departing from the spirit or scope of the embodiments of the present invention.

In order to clearly describe embodiments of the present invention, parts irrelevant to the description are omitted, and the same reference numerals are assigned to the same or similar components throughout the specification.

Since the size and thickness of each component shown in the drawings is arbitrarily shown for convenience of explanation, embodiments of the present invention are not necessarily limited to what is shown in the drawing, and the thickness is enlarged to clearly express various parts and areas.

In addition, in the detailed description below, the names of the components are divided into first, second, etc. to distinguish them because the configurations are the same, and the order is not necessarily limited in the following description.

Throughout the specification, when a part includes a certain component, this means that it may further include other components without excluding other components unless otherwise stated.

In addition, terms such as “unit” and “means” described in the specification mean a comprehensive unit of configuration that performs at least one function or operation.

When a part such as a layer, film, region, plate, etc. is said to be “on” another part, this includes not only the case of being directly on the other part, but also the case where there is another part in between.

In contrast, when an element is referred to as being “directly on” another element, there are no intervening elements present.

As used herein, ‘vehicle’, ‘vehicular’, ‘automotive’, or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (purpose built vehicles), hydrogen-powered vehicles, and other alternative fuel vehicles (e.g., other than petroleum fuel derived from resources).

Exemplary embodiments will hereinafter be described in detail with reference to the accompanying drawings.

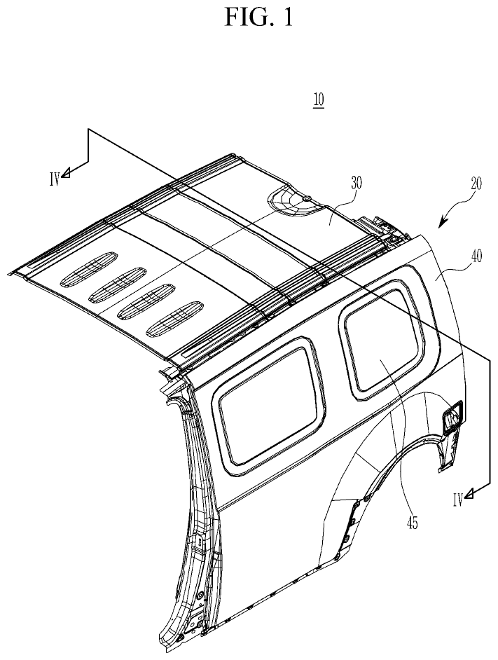

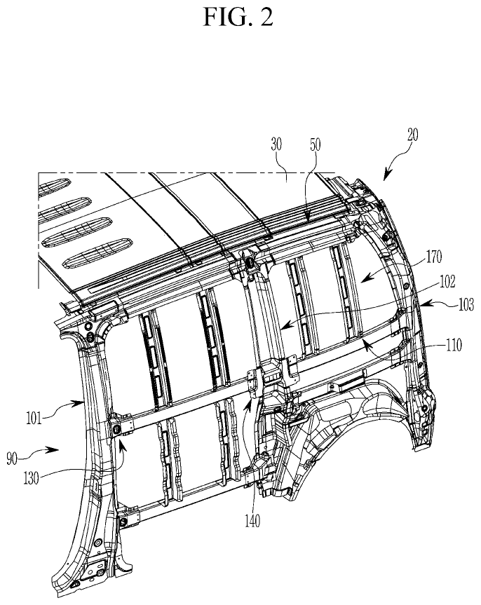

FIG. 1 is a perspective view of a vehicle body to which a vehicle body connecting structure according to an exemplary embodiment may be applied, and FIG. 2 is a perspective view excluding a side outer of the vehicle body to which the vehicle body connecting structure according to an exemplary embodiment may be applied.

Referring to FIG. 1 and FIG. 2, a vehicle body 10 to which a vehicle body connecting structure according to an exemplary embodiment is applied may be a purpose built vehicle (PBV).

In addition, the vehicle body connecting structure according to an exemplary embodiment may be flexibly applied to various vehicle types according to various user needs.

According to the vehicle body connecting structure according to an exemplary embodiment, production cost may be lowered and productivity may be increased by using common parts.

The vehicle body 10 to which the vehicle body connecting structure according to an exemplary embodiment may be applied may include a vehicle body side part 20 coupled to a roof 30, and a side outer 40 may be mounted on the vehicle body side part 20.

As shown in FIG. 1 and FIG. 2, the vehicle body 10 to which the vehicle body connecting structure according to an exemplary embodiment is applied may be applied to a delivery vehicle in which a side panel 45 is mounted on the side outer 40.

In addition, the vehicle body 10 to which the vehicle body connecting structure according to an exemplary embodiment is applied may be a hailing vehicle equipped with a vehicle window instead of the side panel 45.

This will be described later.

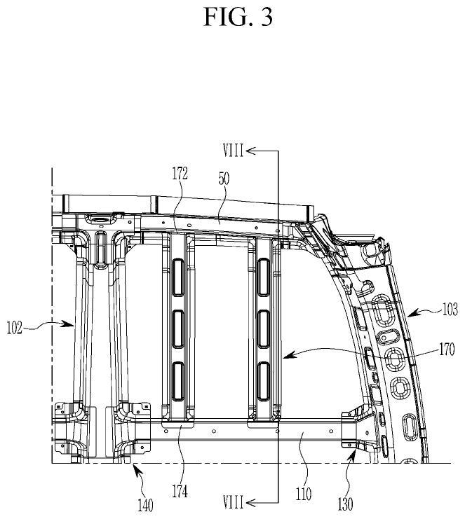

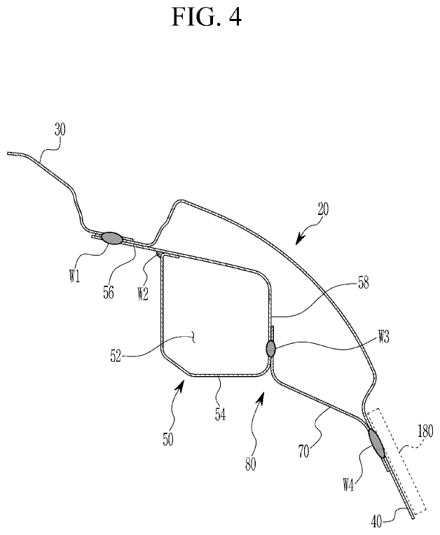

FIG. 3 is a partial side view of the vehicle body to which a vehicle body connecting structure according to an exemplary embodiment may be applied, and FIG. 4 is a cross-sectional view along line IV-IV in FIG. 1.

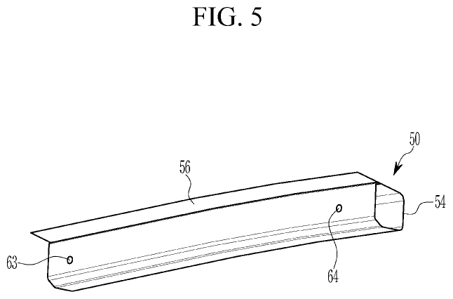

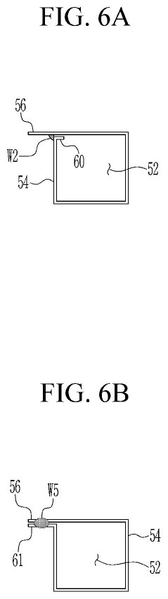

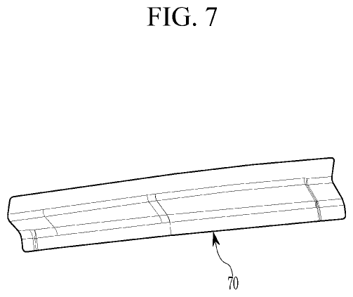

FIG. 5 is a perspective view of a quarter pillar upper reinforcement part of the vehicle body connecting structure according to an exemplary embodiment, FIG. 6A and FIG. 6B are side views of the quarter pillar upper reinforcement part of the vehicle body connecting structure according to an exemplary embodiment, and FIG. 7 is a perspective view of an upper flange bracket of the vehicle body connecting structure according to an exemplary embodiment.

The vehicle body connecting structure according to an exemplary embodiment may include the vehicle body side part 20 including the roof 30 and the side outer 40 connected to the roof 30, a quarter pillar upper reinforcement 50 including a pillar upper reinforcement body 54 of which an upper tubular closed cross-section 52 is formed thereto, an upper connecting flange 56 formed to protrude from the pillar upper reinforcement body 54, and an upper flange bracket 70 that is connected with the pillar upper reinforcement body 54 and forms a quarter upper skeleton 80 in the length direction of the upper portion.

The quarter pillar upper reinforcement 50 may be mounted inside the vehicle body side part 20 through the upper connecting flange 56 and the upper flange bracket 70.

The upper connecting flange 56 may be connected to the roof 30, and the upper flange bracket 70 may be connected to the side outer 40.

The vehicle body connecting structure according to an exemplary embodiment may be applied to various sizes and vehicle types by using the quarter pillar upper reinforcement 50 in the form of a roll-formed square tube tubular and the upper flange bracket 70.

In addition, the vehicle body connecting structure according to an exemplary embodiment may strengthen the upper strength of the vehicle body 10 by applying the quarter pillar upper reinforcement 50 and the upper flange bracket 70 without applying a separate inner panel or reinforcing member.

In the vehicle body connecting structure according to an exemplary embodiment, the cross-section size of the quarter pillar upper reinforcement 50 is standardized, and the length is adjusted to apply to various types, for example, a hailing vehicle or a delivery vehicle.

The quarter pillar upper reinforcement 50 is manufactured in a tubular form with relatively little change in shape and curvature in consideration of the design condition of the vehicle, and the upper flange bracket 70 may be applied to the side that requires a relatively high design degree of freedom.

In the vehicle body connecting structure according to an exemplary embodiment, the tubular configuration of the constant cross-section of the quarter pillar upper reinforcement 50 enables design expansion, so it is easy to change the size (length change) of the tubular product when increasing or reducing vehicle specifications. In addition, it can be produced with the same roll mold, so the production cost can be lowered.

The upper flange bracket 70 may be connected with an exterior surface 58 of the pillar upper reinforcement body 54.

In the case of delivery vehicles, there are cases where interior trim parts are not applied, and if the welding part is excessively exposed, the appearance may deteriorate and affect the marketability.

However, since the upper flange bracket 70 is connected with the exterior surface 58 of the pillar upper reinforcement body 54, exposure of a welding portion, for example, a joint portion of the upper flange bracket 70 and the pillar upper reinforcement body 54 based on the inside of the vehicle may be blocked.

As shown in FIG. 5, component mount holes 63 and 64 may be formed in the pillar upper reinforcement body 54.

A quarter pillar trim, wiring, a CAB, etc. may be mounted using the component mount holes 63 and 64.

Referring to FIG. 6A, the quarter pillar upper reinforcement 50 may include a closed cross-section flange 60 bent inwardly of the upper tubular closed cross-section 52 at one end of the pillar upper reinforcement body 54.

Referring to FIG. 4 and FIG. 6A, the roof 30, the vehicle body side part 20, and the upper connecting flange 56 may be integrally welded W1.

For example, the roof 30, the vehicle body side part 20, and the upper connecting flange 56 are integrally connected with spot welding W1 to simplify the assembly process of the vehicle body 10 and increase the strength of the vehicle body 10.

The closed cross-section flange 60 may be connected by welding W2 while being folded inwardly of the upper tubular closed cross-section 52, for example by laser welding.

If the closed cross-section flange 60 is folded and welded to the inside of the upper tubular closed cross-section 52, the exposure of the welding area relative to the inside of the vehicle may be minimized.

As described above, the upper flange bracket 70 is welded W3 to the exterior surface 58 of the pillar upper reinforcement body 54 to minimize exposure. For example, after the upper flange bracket 70 and the quarter pillar upper reinforcement 50 are welded by one-way welding, the upper connecting flange 56 may be welded W1 to the roof 30 and the vehicle body side part 20.

Alternatively, referring to FIG. 6B, the quarter pillar upper reinforcement 50 May include a closed cross-section flange 61 bent outwardly of the upper tubular closed cross-section 52 at one end of the pillar upper reinforcement body 54.

With the closed cross-section flange 61 folded outwardly of the upper tubular closed cross-section 52, the closed cross-section flange 61 may be connected with the closed cross-section 52 by welding W5, for example, by spot welding.

When the closed cross-section flange 61 is folded and welded to the outside of the upper tubular closed cross-section 52, the welding step may be simplified, and the strength of the flange face side may be increased by the double flange face.

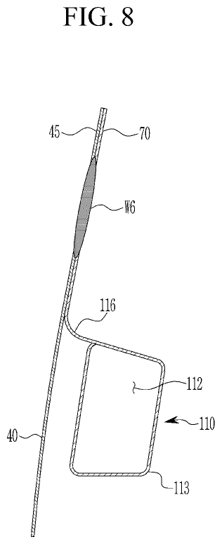

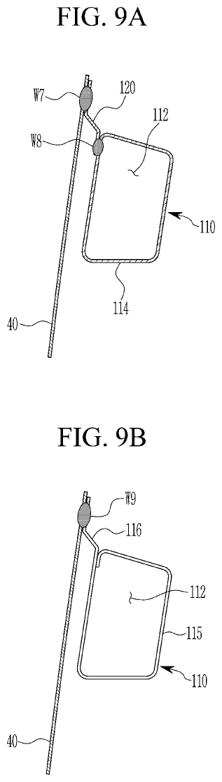

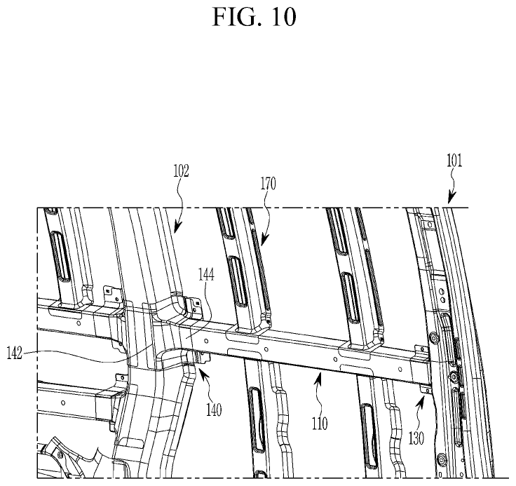

FIG. 8 is a cross-sectional view along line VIII-VIII in FIG. 3, it shows a quarter pillar lower reinforcement part of the vehicle body connecting structure according to an exemplary embodiment, and FIG. 9A and FIG. 9B are cross-sectional views showing exemplary variations of a quarter pillar lower reinforcement part of the vehicle body connecting structure according to an exemplary embodiment.

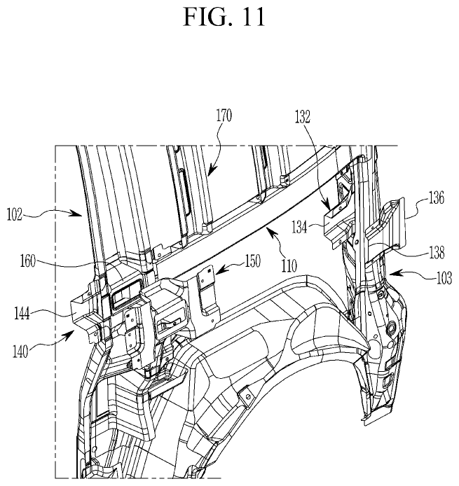

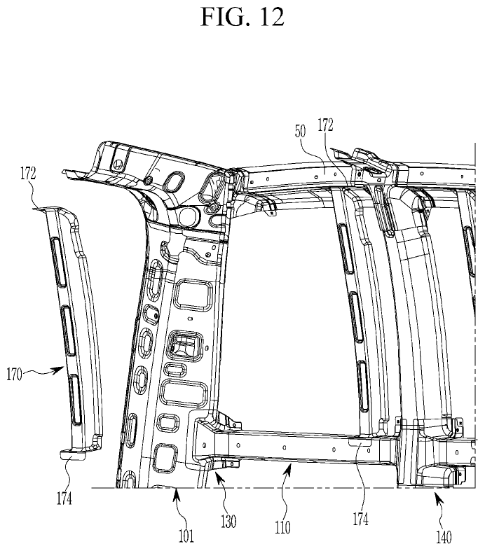

FIG. 10 is a partial perspective view viewed from the inside of the vehicle body to which the vehicle body connecting structure according to an exemplary embodiment may be applied, FIG. 11 is a partial perspective view from the outside of the vehicle body to which the vehicle body connecting structure according to an exemplary embodiment may be applied, and FIG. 12 is a partially exploded perspective view viewed from the inside of the vehicle body to which the vehicle body connecting structure according to an exemplary embodiment may be applied.

Referring to FIG. 1 to FIG. 12, the vehicle body connecting structure according to an exemplary embodiment may further include at least two pillar parts 101, 102, and 103 disposed in the height direction of the vehicle body to form a lateral skeleton 90 of the vehicle body and a quarter pillar lower reinforcement 110 mounted on the lower portion of the quarter pillar upper reinforcement 50 to connect the pillar parts 101, 102, and 103.

Typically, a pillar installed in front of a vehicle body is referred to as an A-pillar (not shown), and based on FIG. 2, a B-pillar 101, a C-pillar 102, and a D-pillar 103 may be mounted sequentially from the left.

However, the vehicle body connecting structure according to an exemplary embodiment is not limited to the three pillar parts 101, 102, and 103 at the rear of the vehicle body 10 shown in the detailed description and drawings of embodiments of the present invention, and two or four or more pillars may be mounted depending on the vehicle's requirements.

For ease of understanding, pillars shown from the left on the basis of FIG. 2 are referred to as a first pillar 101, a second pillar 102, and a third pillar 103, and the second pillar 102 will also be described as a center pillar.

The quarter pillar lower reinforcement 110 may include a pillar lower reinforcement body 113 of which a lower tubular closed cross-section 112 is formed thereto and a lower connecting flange 116 protruded from the pillar lower reinforcement body 113 and connected with the side outer 40.

The vehicle body connecting structure according to an exemplary embodiment may further include a side outer support bracket 170 connecting the quarter pillar upper reinforcement 50 and the quarter pillar lower reinforcement 110.

As shown in FIG. 3 and FIG. 8, the vehicle body 10 to which the vehicle body connecting structure according to an exemplary embodiment is applied may be a delivery vehicle in which the side panel 45 is mounted on the side of the side outer 40, and the side outer support bracket 170 may reinforce the lateral strength of the vehicle body 10.

The side outer support bracket 170 may be connected to the side outer 40 and/or the side panel 45.

In the vehicle body connecting structure according to an exemplary embodiment, the quarter pillar lower reinforcement 110 may have a square tubular shape of roll forming, and it is applicable to various sizes and vehicle types using the quarter pillar lower reinforcement 110.

That is, in the vehicle body connecting structure according to an exemplary embodiment, the cross-section size of the quarter pillar lower reinforcement 110 is standardized, and the length is adjusted to apply to various types, for example, a hailing vehicle or a delivery vehicle.

The lower connecting flange 116 may be welded W6 with the side outer 40. And additionally, the lower connecting flange 116 may be welded W6 to the side panel 45 and/or the side outer support bracket 170 to reduce the number of steps in the manufacturing process.

Referring to FIG. 9A, the quarter pillar lower reinforcement 110 may include a pillar lower reinforcement body 114 in which a lower tubular closed cross-section 112 is formed and a lower flange bracket 120 connecting the pillar lower reinforcement body 114 and the side outer 40.

Referring to FIG. 4, the vehicle body 10 to which the vehicle body connecting structure according to an exemplary embodiment is applied may be a vehicle on which a glass 180 is mounted.

That is, the vehicle body 10 to which the vehicle body connecting structure according to an exemplary embodiment is applied may be a vehicle in which the glass 180 is mounted instead of the side panel 45, and may be, for example, a hailing vehicle in which occupants ride.

When the vehicle body 10 to which the vehicle body connecting structure according to an exemplary embodiment is applied is applied to a hailing vehicle, the pillar lower reinforcement body 114 may be welded W8 to the lower flange bracket 120, and the lower flange bracket 120 may be welded W7 to the upper portion of the side outer 40.

Also, referring to FIG. 9B, the quarter pillar lower reinforcement 110 may include a pillar lower reinforcement body 115, in which a lower tubular closed cross-section 112 is formed, and a lower connecting flange 116 protruded from the pillar lower reinforcement body 115 and connected with the side outer 40.

For example, when the vehicle body 10 to which the vehicle body connecting structure according to an exemplary embodiment is applied is applied to a hailing vehicle, the lower connecting flange 116 may be welded W9 to the upper portion of the side outer 40.

In the vehicle body connecting structure according to an exemplary embodiment, the quarter pillar lower reinforcement 110 is made into a roll-formed square tube tubular shape, the cross-section size is standardized, and the length is adjusted so that it can be used in various forms such as a hailing vehicle or a delivery vehicle.

Through this, it is possible to share parts and lower the production cost of multi-model production.

Referring to FIG. 2, FIG. 3, and FIG. 10 to FIG. 12, the vehicle body connecting structure according to an exemplary embodiment may further include a joint bracket 130 connecting the pillar parts 101 and 103 and the quarter pillar lower reinforcement 110.

For example, the joint bracket 130 is mounted on the first pillar 101 and the third pillar 103 of the vehicle body 10 shown in FIG. 2, but is not limited thereto, and any one of the pillar parts 101, 102, and 103 and the quarter pillar lower reinforcement 110 may be connected.

The joint bracket 130 may include a bracket main body 132 formed with a joint part 134 surrounding the quarter pillar lower reinforcement 110.

The joint bracket 130 may further include a joint cover 136 that is connected to the bracket main body 132 and surrounds the quarter pillar lower reinforcement 110.

The drawing shows that the bracket main body 132 and the joint cover 136 are combined and the joint part 134 has a square cross-section, but the embodiments are not limited thereto. The bracket main body 132 and the joint cover 136 may be formed in a cross-section shape corresponding to the shape of the quarter pillar lower reinforcement 110.

The joint part 134 of the bracket main body 132 and the joint cover 136 may be joined to the quarter pillar lower reinforcement 110 by welding, for example, by one-way welding.

The pillars 101 and 103 and the quarter pillar lower reinforcement 110 may be connected through the joint bracket 130, or through the joint bracket 130 and the joint cover 136, so it may be applied as a common part to various vehicle body specifications, and through this, the production cost may be lowered.

The pillar part may include the center pillar part 102 on which the quarter pillar lower reinforcement 110 is mounted on both sides.

In the detailed description and claims of embodiments of the present invention, referring to the drawing for convenience of understanding, the center pillar part 102 is described as the second pillar 102 among the three pillars mounted at the rear of the vehicle body 10 shown in the drawing, but it is not limited thereto. The center pillar part 102 may be defined as a configuration in which two of the quarter pillar lower reinforcements 110 may be mounted on both sides.

The vehicle body connecting structure according to an exemplary embodiment may further include a center joint bracket 140 connecting the center pillar part 102 and the quarter pillar lower reinforcement 110 on both sides.

The center joint bracket 140 may include a center part body 142 connected with the center pillar part 102 and a reinforcement connecting body 144 surrounding the quarter pillar lower reinforcement 110 on both sides.

The center joint bracket 140 may further include a center bracket cover 150 that surrounds the quarter pillar lower reinforcement 110 on both sides and is connected with the reinforcement connecting body 144.

The drawing shows that the reinforcement connecting body 144 and the center bracket cover 150 are connected and have a square cross-section, but the embodiments are not limited thereto. The reinforcement connecting body 144 and the center bracket cover 150 may be formed in a cross-section shape corresponding to the shape of the quarter pillar lower reinforcement 110.

The center bracket cover 150 surrounds one side of the center pillar part 102 and is connected to the quarter pillar lower reinforcement 110 on both sides to reinforce the connection between the quarter pillar lower reinforcement 110 and the center pillar part 102.

The vehicle body connecting structure according to an exemplary embodiment may further include a center joint bulk head 160 mounted inside the center joint bracket 140.

The center joint bulk head 160 may reinforce the connectivity between the quarter pillar lower reinforcement 110 on both sides and distribute the crash load in the event of a vehicle collision.

The side outer support bracket 170 may include side outer support bracket flanges 172 and 174 formed to surround the quarter pillar upper reinforcement 50 and the quarter pillar lower reinforcement 110 at both ends thereof, respectively.

The side outer support bracket 170 is connected to the quarter pillar upper reinforcement 50 and the quarter pillar lower reinforcement 110 through the side outer support bracket flanges 172 and 174 to reinforce the lateral direction strength of the vehicle body 10.

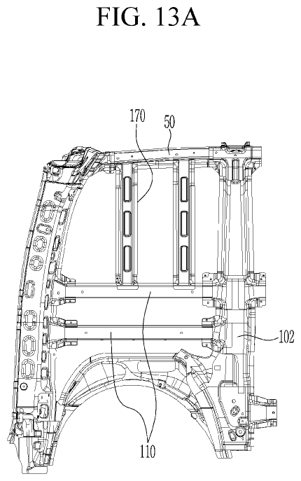

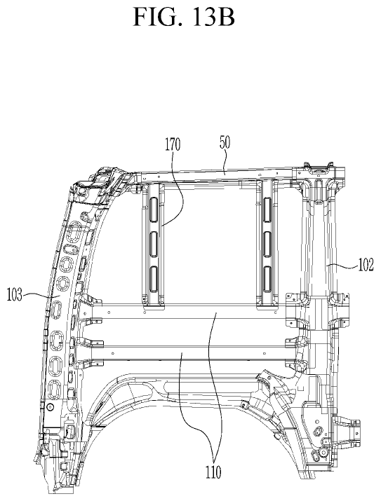

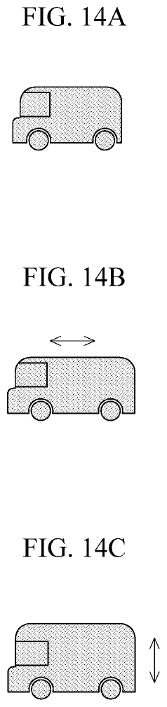

FIG. 13A and FIG. 13B are drawings showing application examples of the vehicle body connecting structure according to an exemplary embodiment, and FIG. 14A, FIG. 14B, and FIG. 14C are drawings showing examples of a vehicle body connecting structure applied to vehicle bodies of various specifications.

As shown in FIG. 13A and FIG. 13B, the vehicle body connecting structure according to an exemplary embodiment may be applied to various vehicle types, so vehicle parts may be shared, and costs such as molds required for manufacturing various vehicle types may be reduced by changing the lengths of the quarter pillar upper reinforcement 50 and the quarter pillar lower reinforcement 110.

Based on the basic vehicle shown in FIG. 14A and the design change that increased the length of the vehicle shown in FIG. 14B, it is possible to respond by adjusting the lengths of the quarter pillar upper reinforcement 50 and the quarter pillar lower reinforcement 110.

Also, even for the design change in which the vehicle length and total height are increased as shown in FIG. 14C, if the design is changed only for the changes in the pillar length, it is possible to share the parts and lower the production cost.

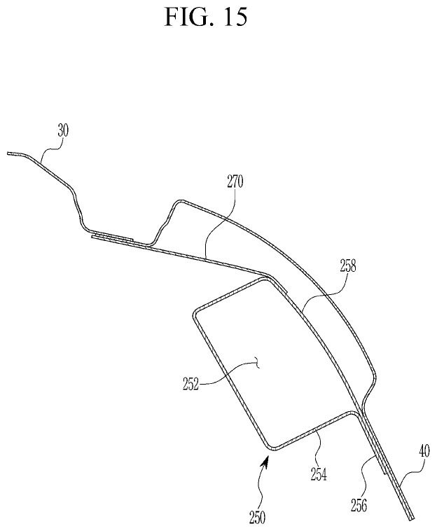

FIG. 15 is a partial cross-sectional view of a vehicle body connecting structure according to a modified exemplary embodiment of the present invention.

In the description of the vehicle body connecting structure according to the modified exemplary embodiment of the present invention of FIG. 15, the same reference numerals are used for the same components as the vehicle body connecting structure according to the embodiments of the present invention described above, and repeated descriptions are omitted.

The vehicle body connecting structure according to the modified example embodiment of the present invention shown in FIG. 15 may include a quarter pillar upper reinforcement 250 including a pillar upper reinforcement body 254 formed with an upper tubular closed cross-section 252 and an upper connecting flange 256 protruding from the pillar upper reinforcement body 254 and an upper flange bracket 270 connected with the pillar upper reinforcement body 254.

The upper connecting flange 256 may be connected to the side outer 40, and the upper flange bracket 270 may be connected to the roof 30.

That is, the vehicle body connecting structure according to the modified exemplary embodiment of the present invention is a structure in which the positions of the upper connecting flange 256 and the quarter pillar upper reinforcement 250 are changed compared to the vehicle body connecting structure according to an exemplary embodiment described above. By adjusting the size of the quarter pillar upper reinforcement 250 and the quarter pillar lower reinforcement 110, it may be applied to various vehicle types, thereby reducing the production cost of multi-vehicle type production.

As described above, the vehicle body connecting structure according to the exemplary embodiments may be flexibly applied to various vehicle types according to various user needs.

In addition, according to the vehicle body connecting structure according to the exemplary embodiments, production cost may be lowered and productivity may be increased by using common parts.

While embodiments of the invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A connecting structure for a vehicle body, the structure comprising:
a vehicle body side part comprising a roof and a side outer connected with the roof;
a quarter pillar upper reinforcement comprising a pillar upper reinforcement body and an upper connecting flange protruding from the pillar upper reinforcement body, the pillar upper reinforcement body having an upper tubular closed cross-section; and
an upper flange bracket connected with the pillar upper reinforcement body and defining a quarter upper skeleton in a length direction of an upper portion, wherein the quarter pillar upper reinforcement is mounted inside the vehicle body side part through the upper connecting flange and the upper flange bracket.

2. The structure of claim 1, wherein:
the upper connecting flange is connected to the roof; and
the upper flange bracket is connected to the side outer.

3. The structure of claim 1, wherein the upper flange bracket is connected with an exterior surface of the pillar upper reinforcement body.

4. The structure of claim 1, further comprising a component mount hole provided in the pillar upper reinforcement body.

5. The structure of claim 1, wherein:
the upper connecting flange is connected to the side outer; and
the upper flange bracket is connected with the roof.

6. A connecting structure for a vehicle body, the structure comprising:
a vehicle body side part comprising a roof and a side outer connected with the roof;
a quarter pillar upper reinforcement comprising a pillar upper reinforcement body and an upper connecting flange protruding from the pillar upper reinforcement body, the pillar upper reinforcement body having an upper tubular closed cross-section;
an upper flange bracket connected with the pillar upper reinforcement body and defining a quarter upper skeleton in a length direction of an upper portion, wherein the quarter pillar upper reinforcement is mounted inside the vehicle body side part through the upper connecting flange and the upper flange bracket;
a plurality of pillar parts disposed in a height direction of the vehicle body to provide a lateral skeleton of the vehicle body; and
a quarter pillar lower reinforcement mounted on a lower portion of the quarter pillar upper reinforcement to connect the pillar parts.

7. The structure of claim 6, wherein the quarter pillar lower reinforcement comprises:
a pillar lower reinforcement body having a lower tubular closed cross-section; and
a lower connecting flange protruded from the pillar lower reinforcement body and connected with the side outer.

8. The structure of claim 6, wherein the quarter pillar lower reinforcement comprises:
a pillar lower reinforcement body having a lower tubular closed cross-section; and
a lower flange bracket connecting the pillar lower reinforcement body and the side outer.

9. The structure of claim 6, further comprising a joint bracket connecting the pillar parts and the quarter pillar lower reinforcement.

10. The structure of claim 6, further comprising a side outer support bracket connecting the quarter pillar upper reinforcement and the quarter pillar lower reinforcement.

11. The structure of claim 10, wherein the side outer support bracket comprises a side outer support bracket flange surrounding the quarter pillar upper reinforcement and the quarter pillar lower reinforcement at both ends thereof, respectively.

12. The structure of claim 6, wherein:
the upper connecting flange is connected to the roof; and
the upper flange bracket is connected to the side outer.

13. The structure of claim 6, wherein the upper flange bracket is connected with an exterior surface of the pillar upper reinforcement body.

14. The structure of claim 6, further comprising a component mount hole provided in the pillar upper reinforcement body.

15. The structure of claim 6, wherein:
the upper connecting flange is connected to the side outer; and
the upper flange bracket is connected with the roof.

16. A vehicle body;
a vehicle body side part;
a roof coupled to the vehicle body side part;
a side outer mounted on the vehicle body side part;
a side panel or a glass window mounted on the side outer;
a quarter pillar upper reinforcement comprising a pillar upper reinforcement body and an upper connecting flange protruding from the pillar upper reinforcement body, the pillar upper reinforcement body having an upper tubular closed cross-section; and
an upper flange bracket connected with an exterior surface of the pillar upper reinforcement body, wherein the quarter pillar upper reinforcement is mounted inside the vehicle body side part through the upper connecting flange and the upper flange bracket.

17. The vehicle body of claim 16, wherein:
the upper connecting flange is connected to the roof; and
the upper flange bracket is connected to the side outer.

18. The vehicle body of claim 16, further comprising a component mount hole provided in the pillar upper reinforcement body.

19. The vehicle body of claim 16, wherein:
the upper connecting flange is connected to the side outer; and
the upper flange bracket is connected with the roof.

20. The vehicle body of claim 16, further comprising:
a plurality of pillar parts disposed in a height direction of the vehicle body and spaced apart from each other in a length direction of the vehicle body; and
a quarter pillar lower reinforcement mounted on a lower portion of the quarter pillar upper reinforcement to connect the pillar parts.
